(19) United States
(12) Patent Application Publication
(10) Pub. No.: US 2013/0335208 A1
(43) Pub. Date: Dec. 19, 2013

(54) PATIENT CONTROL MODULE WITH CELL AND SMART PHONE CAPABILITIES

(71) Applicant: Molly Bridget Delaney, Eden Prairie, MN (US)

(72) Inventor: Molly Bridget Delaney, Eden Prairie, MN (US)

(21) Appl. No.: 13/894,254

(22) Filed: May 14, 2013

Related U.S. Application Data
(60) Provisional application No. 61/661,426, filed on Jun. 19, 2012.

(51) Int. Cl. G08B 5/22

(52) U.S. Cl. CPC G08B 5/223
USPC 340/286.07

(57) ABSTRACT

A patent control module and associated system allows a patient in a hospital, clinic, or the like, to control room features, such as lights, televisions, and the like, as well as providing cell phone capabilities, such as being able to call or text their nurse, run cell phone applications, play games, and the like. The control module allows a patient to call or text their nurse directly and relay their needs. The cell phone features, such as applications, games and the like, can occupy the patient while they convalesce. The system can provide education modules to patients, where tracking cookies can keep track of those modules completed by patients. The system can provide patients access to their charts, past medical history, consent forms, intake paperwork, regulatory paperwork, and the like.

### CROSS-REFERENCE TO RELATED APPLICATION

This application claims the benefit of priority of U.S. provisional application No. 61/661,426, filed Jun. 19, 2012, the contents of which are herein incorporated by reference.

### BACKGROUND OF THE INVENTION

The present invention relates to communication systems and, more particularly, to a nurse call device with cell phone and smart phone features and capabilities.

Hospital patients have separate devices for a call light and phone. The call light typically triggers a light in the nurse's station, but doesn't provide any information regarding what the patient needs. Usually, the patient has to, once the nurse's station picks up the call light, talk via an intercom. Hospital, clinic or other types of patients have no way to text or call their nurse. These patients are often limited to using a land line phone in their room.

As can be seen, there is a need for a system that enables a patient to contact their nurse with either calling or texting ability while providing other conventional nurse call button functions, television control functions, applications, and the like.

### SUMMARY OF THE INVENTION

In one aspect of the present invention, a control module comprises a nurse call feature, allowing a patient to call a nurse with the control module; a cell phone feature, allowing a patient to call or text the nurse via the control module; and a communication system allowing the control module to communicate with a supporting control system.

In another aspect of the present invention, a control module comprises a nurse call feature, allowing a patient to call a nurse with the control module; a cell phone feature, allowing a patient to call or text the nurse via the control module; a communication system allowing the control module to communicate with a supporting control system; light control buttons for controlling light; television control buttons for controlling a television; a touch sensitive display screen for inputting data into the control module and viewing output from the control module; and at least one speaker and at least one microphone.

These and other features, aspects and advantages of the present invention will become better understood with reference to the following drawings, description and claims.

### BRIEF DESCRIPTION OF THE DRAWINGS

FIG. 1 is a perspective view of a patient control module according to an exemplary embodiment of the present invention; and

FIG. 2 is a front view of the patient control module of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a patent control module and associated system that allows a patient in a hospital, clinic, or the like, to control room features, such as lights, televisions, and the like, as well as providing cell phone capabilities, such as being able to call or text their nurse, run cell phone applications, play games, and the like. The control module of the present invention allows a patient to call or text their nurse directly and relay their needs. The cell phone features, such as applications, games and the like, can occupy the patient while they convalesce. The system of the present invention can provide education modules to patients, where tracking cookies can keep track of those modules completed by patients. The system of the present invention can provide patients access to their charts, past medical history, consent forms, intake paperwork, regulatory paperwork, and the like. For example, with regulatory paperwork, there could be a place for a patient's e-signature to confirm that they have read and understood the notifications, thereby providing an electronic paper trail that can be easy to track and maintain.

In some embodiments of the present invention, the system can include social media links. For example, the present invention can connect to Skype for interpretation, Twitter for support groups, and the like. The system of the present invention can also include “how-to” applications or videos which can be taken from YouTube or the like. The how-to videos can include items like how to change a dressing, how to change a diaper, or the like, depending on the patient's need and application.

The system of the present invention can provide a patient with access points, such as email, applications or the like, to connect to various departments to get/give different information to these departments.

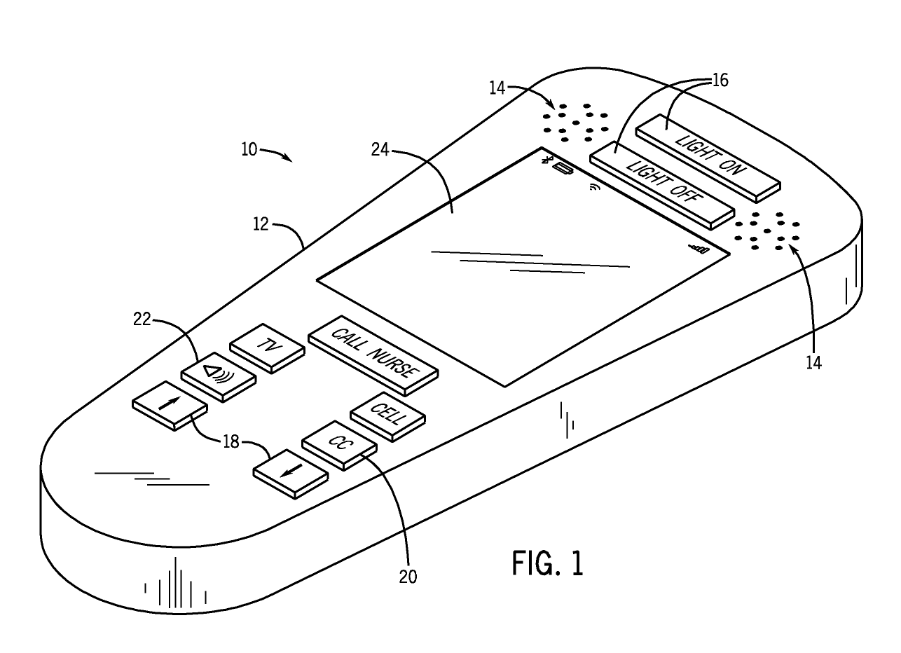

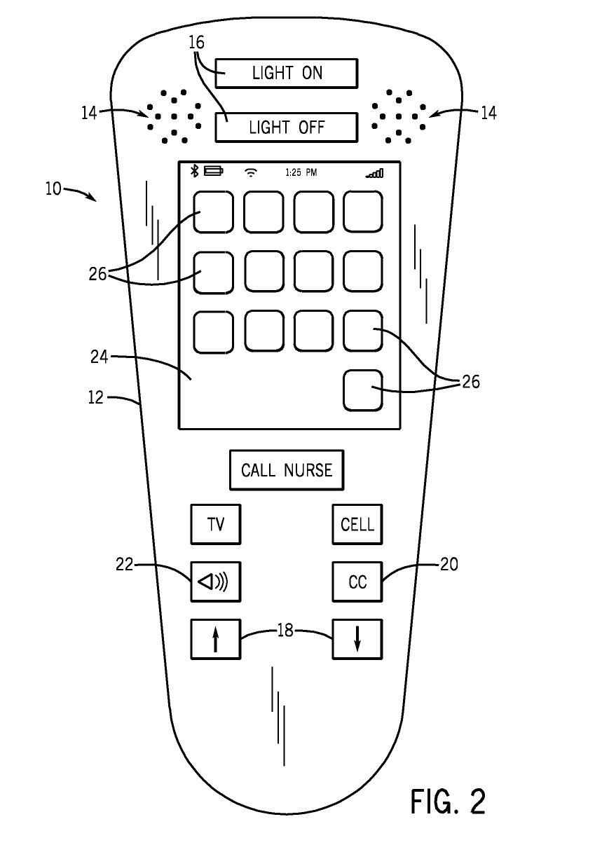

Referring now to FIGS. 1 and 2, the patient control module 10 can include a housing 12 through which various buttons 16, 18, 20, 22 can extend. For example, one or more light control buttons 16 can be provided to control various room lights. Up and down arrows 18 can be provided for various functions, such as television volume and/or channel control. A television closed caption button 20 can be provided to turn on and off closed captioning. A television mute button 22 can be provided to turn of the sound on the television. While these specific buttons are described and shown in the Figures, other buttons can be provided in the control module 10, depending on the end user's application.

Speakers 14 can be provided in the control module 10. The speakers 14 can provide sound from the cell phone applications, from the television, or from a conversation with a nurse. The speakers 14 can also act as a microphone for talking with the nurse via the cell phone features. In some embodiments, a separate microphone can be provided.

The control module 10 can include a display screen 24. In some embodiments, the display screen 24 can be a touch screen. The display screen 24 can be used to access features of the control module 10. For example, if the patient presses the TV button, the display screen 24 can show television channel options that can be selected by touching the screen. If the patient presses the cell button, cell phone options can appear on the screen 24. For example, the patient can be provided with options for texting or calling, or options for running various applications that can be pre-loaded on the control module 10.

The control module 10 can allow a patient to review “my charts”. This can empower the patient to view and document various elements of their care in their chart, monitor education modules/links that they have reviewed, read articles on their health care, and complete/review e-learning modules, for example.

The control module 10 can provide the patient with various other bits of information. For example, the patient can access menus and make menu selections via the control module 10. The patient could access nutrition information about each meal, if desired. The patient could access gift shop information and place an order from the gift shop, if desired.

The control module 10 can use various communications methods to relay signals, such as wireless, Bluetooth, radio frequency and WiFi technology. In some embodiments, the control module 10 can be corded, where the cord not only provides the signals from the control module 10, but also can act as a finding feature. In some embodiments, the control module 10 is adapted for use with the cord and as a wireless device. For example, the cord can be attached for sending signals and/or to act as a finding device, but the patient can also disconnect the cord and take the control module 10 with them, for example, when using the bathroom.

The system of the present invention includes the control module 10 along with the requisite software and hardware to program and control the control modules 10. For example, the system can include a computer system that can receive a request for a cell phone call to the nurse; however, if the nurse is not available, or does not answer after a set number of rings, the computer system can forward the call to the nurse's station or another covering nurse's cell phone, for example. A nurse call button can also be provided, that can directly call the nurse (or nurse's station) without the need to go through the cell phone or texting steps.

The control module 10 can be programmed with various cell phone applications, or, if WiFi enabled, may be used to download games, programs and other applications from the internet. The control module 10 may also be configured with GPS tracking, similar to that found in many smart phones that can allow nurses to determine patient location when they move about while carrying their control module 10. The computer system can alert a nurse when a patient moves beyond a predefined area. The computer system can also control various features of the control module 10, such as when lights must be off for the evening, the maximum television volume for a user, and the like.

The control module of the present invention may also be used in other fields and applications. For example, in place of in-flight call buttons, the control module can be used on aircraft to give passengers the ability to text a flight attendant their needs, saving the flight attendant from coming to the passenger, then back to get something for them, then back to the passenger again. Waitresses could also use the control module of the present invention in a similar way, where restaurant patrons can be given a control module to directly contact their waitress, letting them know what to bring, if they want their check, and the like. In general, the control module can be useful in most any service industry where customers have the need to call or text the service provider.

It should be understood, of course, that the foregoing relates to exemplary embodiments of the invention and that modifications may be made without departing from the spirit and scope of the invention as set forth in the following claims.

What is claimed is:

1. A control module comprising:
a nurse call feature, allowing a patient to call a nurse with the control module;
a cell phone feature, allowing a patient to call or text the nurse via the control module; and
a communication system allowing the control module to communicate with a supporting control system.

2. The control module of claim 1, further comprising light control buttons for controlling lights.

3. The control module of claim 1, further comprising television control buttons for controlling a television.

4. The control module of claim 1, further comprising a display screen.

5. The control module of claim 4, wherein the display screen is a touch screen.

6. The control module of claim 1, wherein the control module is hard wired to communicate with the supporting control system.

7. The control module of claim 1, wherein the control module communicates wirelessly with the supporting control system.

8. The control module of claim 1, further comprising at least one speaker and at least one microphone.

9. A control module comprising:
a nurse call feature, allowing a patient to call a nurse with the control module;
a cell phone feature, allowing a patient to call or text the nurse via the control module;
a communication system allowing the control module to communicate with a supporting control system;
light control buttons for controlling light;
television control buttons for controlling a television;
a touch sensitive display screen for inputting data into the control module and viewing output from the control module; and
at least one speaker and at least one microphone.

10. The control module of claim 9 wherein the control module can communicate wirelessly with the supporting control system and the control module can be hard wired to communicate with the supporting control system.
